(19) United States
(12) Patent Application Publication
(10) Pub. No.: US 2025/0269573 A1
(43) Pub. Date: Aug. 28, 2025

(54) MOLDING MANAGEMENT SYSTEM

(71) Applicant: SEIKO EPSON CORPORATION, Tokyo (JP)

(72) Inventors: Tomohiro TAKIZAWA, MATSUMOTO-SHI (JP); Kosuke ATSUTA, SHIOJIRI-SHI (JP); Soji SHIOZAWA, MATSUMOTO-SHI (JP)

(21) Appl. No.: 19/063,706

(22) Filed: Feb. 26, 2025

(30) Foreign Application Priority Data
Feb. 28, 2024 (JP) 2024-028372

(51) Int. Cl. B29C 45/76; B22F 3/22

(52) U.S. Cl. CPC B29C 45/76; B22F 3/225; B22F 2203/00; B29C 2045/7606; B29C 2945/76939

(57) ABSTRACT

A molding management system that manages production of a product in a production process including an injection molding process of the product by an injection molding device. The molding management system including a server with a storage section configured to store one or more sets of lot information in which lot identification information for identifying a lot and lot related information are associated with each other and a control section configured to cause a terminal device to display a material consumption action related information addition image that receives a material consumption action related information addition operation for adding material consumption action related information related to an action of consuming the material used for molding the product for adjustment a target injection molding device to the lot information indicating a target lot selected from the lots indicated by one or more sets of the lot information.

The present application is based on, and claims priority from JP Application Serial Number 2024-028372, filed Feb. 28, 2024, the disclosure of which is hereby incorporated by reference herein in its entirety.

### BACKGROUND

### 1. Technical Field

This disclosure relates to a molding management system.

### 2. Related Art

Research and development have been conducted on a technique for managing the production of a product in a production process including an injection molding stage of the product by an injection molding device using a material such as plastic.

In this regard, a system is known in which control information for controlling the molding of the product for each lot can be updated for each molding of the product (see JP-B-7-029352).

In a system such as that described in JP-B-7-029352, when actions that reduce the amount of material used for molding of the product are performed in order to adjust the injection molding device, a difference may occur between the actual lot and the lot in the system. This is because the lot is managed by the master data in the system, but it is not desirable from the viewpoint of lot management. Note that it should be noted that the above described actions are, for example, purging of the material, trial shot by the injection molding device, and the like, but are not limited to these.

### SUMMARY

To solve the above described problem, an aspect of the present disclosure provides a molding management system that manages production of a product in a production process including an injection molding process of the product by an injection molding device, the molding management system including a server communicably connected to a terminal device, wherein the server includes a storage section configured to store one or more sets of lot information in which lot identification information for identifying a lot and lot related information including one or more sets of information relating to the lot are associated with each other and a control section configured to cause the terminal device to display a material consumption action related information addition image for receiving a material consumption action related information addition operation for adding, to the lot information indicating a target lot selected from the lots indicated by one or more sets of the lot information stored in the storage section, material consumption action related information related to an action that consumes the material used for molding the product for adjustment of the injection molding device.

### BRIEF DESCRIPTION OF THE DRAWINGS

FIG. 1 is a diagram showing an example of a configuration of a molding management system 1.

FIG. 2 is a diagram showing an example of a main menu image P1.

FIG. 3 is a diagram showing an example of a terminal image P2.

FIG. 4 is a diagram showing an example of a material consumption action related information addition image P3.

FIG. 5 is a diagram showing an example of a target manufacturing lot selection operation reception image P5 displayed by a selection operation at the button B31 shown in FIG. 4.

FIG. 6 is a diagram showing an example of a purge related information input image P6.

FIG. 7 is a diagram showing an example of a trial shot related information input image P7.

FIG. 8 is a diagram showing an example of a correspondence relationship reception image P8.

FIG. 9 is a diagram showing an example of a hardware configuration of a server 30.

FIG. 10 is a diagram showing an example of a functional configuration of the server 30.

FIG. 11 is a diagram showing an example of a flow of process in which the server 30 adds a material consumption action related information to a manufacturing lot information.

### DESCRIPTION OF EMBODIMENTS

### Embodiment

Hereinafter, embodiments of the present disclosure will be described with reference to the drawings.

### Overview of Molding Management System

First, an outline of the molding management system according to the embodiment will be described.

A molding management system according to the embodiment manages the production of a product in a production process including an injection molding process of the product by an injection molding device. The molding management system includes a server. The server is communicatively connected to a terminal device. The server includes a storage section and a control section. The storage section stores one or more sets of the lot information in which lot identification information that identifying a lot and lot related information including one or more sets of information relating to the lot are associated with each other. The control section causes the terminal device to display a material consumption action related information addition image receives a material consumption action related information addition operation for adding material consumption action related information relating to an action of consuming the material used for molding the product for adjustment of the injection molding device to the lot information indicating a target lot selected from the lots indicated by one or more sets of the lot information stored in the storage section.

By this, when an action of consuming the material used for mold the product in order to adjust the injection molding device, the molding management system according to the embodiment can suppress the occurrence of a difference between the actual lot and the lot on the molding management system.

Hereinafter, each of the configurations of the molding management system according to the embodiment and the process performed by the server included in the molding management system will be described in detail.

Note that the above described material consumption actions are, for example, purging of the material, trial shot by the injection molding device, and the like. In various systems for managing the molding of the product by the injection molding device, it is difficult to determine that material has been used due to purging of the material, trial shots by the injection molding device, and the like. This is because, for example, when the injection molding device is manually operated, only an operator who operates the injection molding device knows in many cases whether the operation of the injection molding device is performed for molding the product, trial shot, or purging. When the injection molding device is automatically operated, molding of the first and last products that are difficult to stabilize in quality may be handled as trial shot by the judgment of the operator. Under such circumstances, as described above, the molding management system according to the embodiment is useful because it is possible to suppress the occurrence of a difference between the actual lot and the lot on the molding management system when an action of consuming the material used for mold the product in order to adjust the injection molding device.

### Configuration of the Molding Management System

Hereinafter, the configuration of the molding management system according to the embodiment will be described using a molding management system 1 as an example.

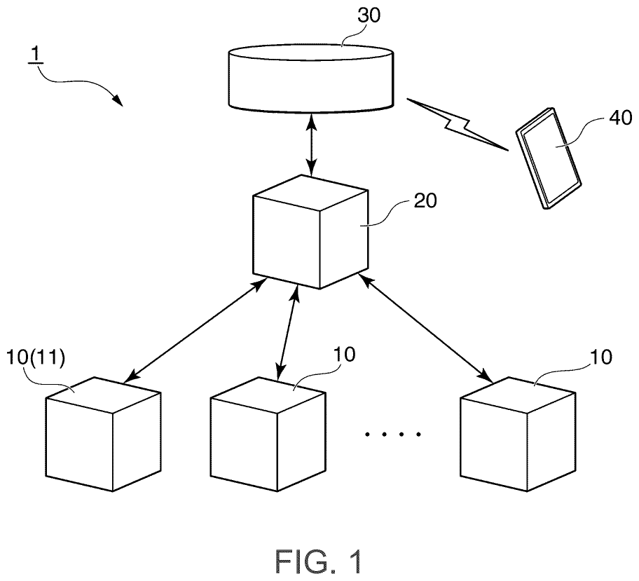

FIG. 1 is a diagram showing an example of a configuration of the molding management system 1.

The molding management system 1 is a kind of Manufacturing Execution System (MES). For example, the molding management system 1 includes one or more of managed devices 10, an information process device 20, and a server 30. Note that the molding management system 1 may be configured not to include part or all of one or more of the managed devices 10. The molding management system 1 may have a configuration that does not include the information process device 20. Hereinafter, as an example, a case where the molding management system 1 includes a plurality of managed devices 10 as one or more of the managed devices 10 will be described.

Each of the plurality of managed devices 10 included in the molding management system 1 is a device managed by the molding management system 1. In FIG. 1, each of the plurality of managed devices 10 is indicated by the same reference symbol for convenience of explanation. However, some or all of the plurality of managed devices 10 may be different types of managed devices. The plurality of managed devices 10 includes at least one of injection molding device that performs injection molding of the product using a resin such as plastic. An injection molding device 11 shown in FIG. 1 is an example of such an injection molding device. Note that the plurality of managed devices 10 may include the injection molding device that performs metal powder injection molding (MIM: Metal Injection Molding) of the product. Hereinafter, for convenience of description, the injection molding of a product using a resin such as plastic will be simply referred to as injection molding. In the following description, the injection molding device that performs injection molding of the product using a resin such as plastic is simply referred to as the injection molding device. The plurality of managed devices 10 includes, for example, a peripheral equipment of the injection molding device in addition to the injection molding device. The peripheral equipment of the injection molding device includes, for example, a material supply device for supplying the injection molding device with material used in injection molding of the product by the injection molding device, a transport device for transporting the product of injection molding by the injection molding device, a cleaning device for cleaning the product of injection molding by the injection molding device, a sintering device for sintering the product after being cleaned by the cleaning device, and the like, but is not limited to these. At least one injection molding device included in the plurality of managed devices 10 may be a device for performing injection molding using a material other than resin and metal.

The molding management system 1 manages the production of a product in the production process, which includes the injection molding process of the product by the injection molding device included in the plurality of managed devices 10. Here, the injection molding device included in the plurality of managed devices 10 may have any configuration as long as it is capable of producing the product by injection molding. Hereinafter, for convenience of description, one injection molding of the product by the injection molding device will be referred to as one shot and described. In this case, for example, two shots mean injection molding of the product twice by the injection molding device. Hereinafter, for convenience of description, each of one or more of the cavities in a metal mold filled with a resin in the molding of the product in one shot will be described as a cavity. For example, the injection molding device fitted with the metal mold having two such cavities will mold two products in one shot.

Note that hereinafter, for convenience of description, a group of one or more of the products to which product lot identification information is assigned for management reasons will be referred to as a product lot. Here, the product lot identification information may be any information as long as it can identify the product lot, for example, an ID (Identifier) that identifies the product lot, a character string for identifying the product lot, or any other identification information capable of identifying the product lot. Hereinafter, for convenience of description, a product to which product lot identification information for identifying a certain product lot is assigned will be referred to as a product of the product lot. The product lot is an example of the lot. The product lot identification information is an example of the lot identification information.

Hereinafter, for convenience of description, a group of materials to which material lot identification information is assigned for management reasons is referred to as a material lot. Here, the material lot identification information may be any information as long as it can identify the material lot, for example, the information may be an ID that identifies the material lot, a character string that identifies the material lot, or other information capable of identifying the material lot. Hereinafter, for convenience of description, a material to which material lot identification information for identifying a certain material lot is assigned will be referred to as a material of the material lot.

The information process device 20 acquires state information indicating the state of each of the plurality of managed devices 10 from the managed device 10. For example, the information process device 20 acquires the state information of the injection molding device 11 from the injection molding device 11. Such state information includes a time stamp indicating the date and time when the state information was acquired by the information process device 20. Certain state information includes device identification information for identifying the managed device 10 in the state indicated by the state information. The state information includes detection information detected by one or more of the various sensors attached to the managed device 10. The detection information includes, for example, information indicating a temperature, information indicating a pressure, information indicating a current value, and information indicating a voltage value. That is, one or more of the various sensors are, for example, a thermometer, a pressure gauge, an ammeter, a voltmeter, and the like, but are not limited to these. Note that the detection information may include configurations where other information detected by the sensor is included instead of a part or all of the above information or in addition to all of the above information. The state information includes operating state information indicating the operating state of the managed device 10. The operating state information indicating the operating state of the managed device 10 may be any state information as long as it includes information indicating whether or not the managed device 10 is operating. The acquisition of state information by the information process device 20 may be performed periodically or non-periodically. Hereinafter, as an example, a case where the state information is acquired by the information process device 20 every time the one shot described above is performed will be described. When the information process device 20 acquires certain state information, it outputs the acquired state information to the server 30. By this, the information process device 20 can store the acquired state information in the server 30.

The information process device 20 is, for example, a workstation, a desktop Personal Computer (PC), a notebook PC, or the like, but is not limited to these. The information process device 20 is communicably connected to each of the plurality of managed devices 10 via wired or wireless communication. A communication network for connecting the information process device 20 and each of the managed devices 10 is, for example, a Local Area Network (LAN) in a facility where the plurality of managed devices 10 is installed, but is not limited to this. The communication network may be another communication network such as the Internet or a mobile communication network.

The server 30 stores the state information acquired by the information process device 20. For example, when the server 30 acquires certain state information from the information process device 20, the server 30 stores the acquired state information. Here, when the server 30 has already stored the state information including the device identification information included in the state information, the server 30 replaces the already stored state information with the newly acquired state information. By this, the server 30 can always keep the state information indicating the state of the managed device 10 indicated by the device identification information to be the latest state information. Note that the server 30 may be configured to store all the acquired state information without performing such a replacement. The server 30 may be configured so that, even when such a replacement is performed, it newly stores the state information before the replacement as the history information indicating the history of the state of the managed device 10.

In response to a request from the terminal device communicably connected to the server 30, the server 30 causes a display section of the terminal device to display various images based on the state information stored in the server 30. Here, the image is a Graphical User Interface (GUI), an icon, a window on an operating system (OS), or the like. Hereinafter, as an example, a case where the server 30 is communicably connected to a terminal device 40 as shown in FIG. 1 will be described below. Note that in the present embodiment, the process relating to the login to the server 30 by the terminal device 40 is a known process, and therefore, the description thereof will be omitted. Hereinafter, for convenience of description, the server 30 receiving an operation from the terminal device 40 via the image displayed on the terminal device 40 will be simply referred to as the server 30 receiving an operation and described. That is, in the following description, the server 30 performs a certain process in response to the received operation means that the server 30 performs the process in response to the operation received from the terminal device 40 via the image displayed on the terminal device 40.

The server 30 accepts various kinds of information according to the received operation. For example, the server 30 stores master data including various kinds of information for the product produced by the injection molding device 11 according to the received operation. The master data includes, for example, product identification information for identifying various products produced by the injection molding device 11, production quantity planned value information indicating the planned value of the production quantity of the product identified by each product identification information, metal mold identification information for identifying a metal mold used to produce the product identified by each product identification information, and the like. The data structure of the master data may be any structure. For example, various kinds of information included in the master data are included in the master data as information associated with the product identification information.

In response to the received operation, the server 30 causes the display section of the terminal device 40 to display a product lot search image for receiving a product lot search operation for searching for the product lot of the product. The display section is, for example, the display of the terminal device 40, a display device communicably connected to the terminal device 40, or the like, but is not limited to this. Hereinafter, as an example, a case where the display section is the display of the terminal device 40 will be described. Hereinafter, for convenience of description, the action of displaying a certain image on the display section will be referred to as displaying the image. The product lot search image is an image for receiving various kinds of information that can be used as a search key, by the above described product lot search operation.

Note that the server 30 stores the product lot identification information and the product lot related information, which includes one or more sets of information relating to the product lot, in association with each other. By this, when the server 30 searches for information on the product of a certain product lot, one or more sets of information included in the product lot related information associated with the product lot identification information can each be used as the search key for searching for the product lot together with the product lot identification information for identifying the product lot. In other words, in the product lot search image, in addition to the product lot identification information, one or more sets of information included in the product lot related information can each be used as the search key for searching the product lot. Hereinafter, for convenience of description, information in which product lot identification information for identifying a certain product lot and product lot related information including one or more sets of information related to the product lot are associated with each other will be referred to as product lot information indicating the product lot. That is, when the server 30 receives, via the product lot search image from the product lot search operation, at least one set of information from the one or more sets of information included in the product lot related information, then the server 30 causes display of the product lot information indicating the product lot identified by each of one or more product lot identification information associated with the received at least one set of information. By this, the server 30 can allow the user to easily search for the information of the product of the product lot desired by the user. Therefore, the server 30 stores one or more sets of product lot information for each set of product lot identification information. Here, the product lot information is, for example, information that is generated or updated by information received from the user via one of the update functions executable by the server 30, and is information stored in the server 30. Certain product lot information includes, for example, the product lot identification information for identifying the product lot indicated by the product lot information and the product lot related information related to the product lot. More specifically, the product lot related information includes production quantity information indicating the number of products in the product lot, product type information indicating the type of the product in the product lot, process information indicating a work process currently performed on the product of the product lot, product lot state information indicating the state of the product lot, start date and time information indicating the date and time when the production of the product of the product lot was started, quality information indicating the result of a quality inspection performed on the product of the product lot, injection molding device related information relating to the injection molding device for molding the product of the product lot, metal mold identification information for identifying the metal mold attached to the injection molding device, number of cavity information indicating the number of cavities in the metal mold, production plan information indicating a production plan for the product of the product lot, and the like. The quality information is information indicating that a quality inspection has not been performed on the product when the quality inspection has not been performed on the product. The injection molding device related information includes, for example, injection molding device identification information for identifying the injection molding device, the operating state information indicating the operating state of the injection molding device, the detection information on the injection molding device, and the like. Note that the product lot related information may include configurations where other information related to the product lot is included instead of a part or all of the above information or in addition to all of the above information.

The product lot related information included in the product lot information indicating a certain product lot may or may not include the product related information relating to the individual products of the product lot. Hereinafter, as an example, a case where the product related information is included in the product lot related information will be described. The product related information on a certain product includes at least either shot identification information for identifying a shot in which the product is molded or cavity identification information for identifying a cavity in which the product is molded, together with product identification information for identifying the product. Hereinafter, as an example, a case where the product related information includes the shot identification information together with the product identification information and does not include the cavity identification information will be described. Note that the input of the product related information to the server 30 may be performed based on information automatically output from the injection molding device, may be performed manually by the user, or may be performed by another method.

In response to the received operation, the server 30 causes the display section of the terminal device 40 to display a material lot search image for receiving a material lot search operation for searching for the material lot of the material. The material lot search image is an image for receiving various kinds of information that can be used as a search key by a material lot search operation.

Note that the server 30 stores the material lot identification information and the material lot related information, which includes one or more sets of information related to the material lot, in association with each other. By this, when the server 30 searches for information on a material of a certain material lot, one or more sets of information included in the material lot related information associated with the material lot identification information can each be used as the search key for searching for the material lot together with the material lot identification information for identifying the material lot. In other words, in the material lot search image, in addition to the material lot identification information, one or more sets of information included in the material lot related information can each be used as the search key for searching the material lot. Hereinafter, for convenience of description, information in which material lot identification information that identifies a certain material lot and material lot related information including one or more sets of information related to the material lot are associated with each other will be referred to as material lot information indicating the material lot. That is, when the server 30 receives at least one set of information from one or more sets of information included in the material lot related information via the material lot search image by the material lot search operation, then the server 30 causes display of the material lot information indicating the material lot identified by the one or more sets of the material lot identification information associated with the received at least one set of information. By this, the server 30 can allow the user to easily search for the information of the material of the material lot desired by the user. Therefore, the server 30 stores one or more sets of the material lot information for each material lot identification information. Here, the material lot information is, for example, information that is generated or updated by information received from the user via one of the update functions executable by the server 30, and is information stored in the server 30. Certain material lot information includes, for example, the material lot identification information for identifying the material lot indicated by the material lot information and the material lot related information related to the material lot. More specifically, the material lot related information includes material identification information for identifying the material of the material lot, material name information indicating a name of the material, and material remaining amount information indicating a remaining amount of the material. Note that the material lot related information may include configurations where other information related to the material lot is included instead of a part or all of the above information or in addition to all of the above information.

Hereinafter, for convenience of description, a group of one or more of the product lots to which manufacturing lot identification information is assigned for management reasons, that is, a higher level group to which one or more product lots belong, will be referred to as a manufacturing lot. Note that the manufacturing lot may also be referred to as a job. The manufacturing lot identification information may be any information as long as it can identify the identification of the manufacturing lot, for example, the manufacturing lot identification information, a character string that identifies the manufacturing lot, or any other identification information capable of the identification of the manufacturing lot. Hereinafter, for convenience of description, a product lot to which lot identification information for identifying a certain manufacturing lot is assigned will be referred to as a product lot included in the manufacturing lot. For example, the manufacturing lot may be a group of the product lots gathered by a work shift or the like of a manager who manages the production of the product of the product lot, may be a group of the product lots gathered by the product lot related information included in the product lot information indicating the product lot, or may be another group of the product lots. Hereinafter, as an example, a case where the manufacturing lot is a group of product lots gathered by the product lot related information included in the product lot information indicating the product lot will be described. In this case, the product lot information indicating each of one or more of the product lots included in a certain manufacturing lot contains the same product lot related information as the other. The manufacturing lot is an example of a lot. The manufacturing lot identification information is an example of the lot identification information.

In response to the received operation, the server 30 causes display of a manufacturing lot search image for receiving a manufacturing lot search operation for searching for the manufacturing lot. The manufacturing lot search image is an image for receiving various kinds of information that can be used as a search key by a manufacturing lot search operation.

The server 30 stores the manufacturing lot identification information and manufacturing lot related information, which includes one or more sets of information related to the manufacturing lot, in association with each other. By this, when the server 30 searches for information of a certain manufacturing lot, one or more sets of information included in the manufacturing lot related information associated with the manufacturing lot identification information can each be used as the search key for searching for the manufacturing lot together with the manufacturing lot identification information for identifying the manufacturing lot. In other words, in the manufacturing lot search image, in addition to the manufacturing lot identification information, one or more sets of information included in the manufacturing lot related information can each be used as the search key to search for the manufacturing lot. Hereinafter, for convenience of description, information in which manufacturing lot identification information for identifying a certain manufacturing lot and manufacturing lot related information including one or more sets of information related to the manufacturing lot are associated with each other will be referred to as manufacturing lot information indicating the manufacturing lot. That is, when the server 30 receives at least one set of information from one or more sets of information included in the manufacturing lot related information via the manufacturing lot search image by the manufacturing lot search operation, then the server 30 causes display of the manufacturing lot information indicating the manufacturing lot identified by the one or more sets of manufacturing lot identification information associated with the received at least one set of information. By this, the server 30 can allow the user to easily search for information on the manufacturing lot desired by the user. Therefore, the server 30 stores the one or more sets of manufacturing lot information for each manufacturing lot identification information. Here, the manufacturing lot information is, for example, information that is generated or updated by information received from the user via one of the update functions executable by the server 30, and is information stored in the server 30. Certain manufacturing lot information includes, for example, the manufacturing lot identification information for identifying the manufacturing lot indicated by the manufacturing lot information and the manufacturing lot related information related to the manufacturing lot. Note that as in this example, when the manufacturing lot is a group of the product lots gathered by the product lot related information included in the product lot information indicating the product lot, certain manufacturing lot related information may include configurations where the product lot information indicating each of one or more of the product lots included in the manufacturing lot indicated by the manufacturing lot information containing the manufacturing lot related information. In this case, the manufacturing lot related information may be configured to include at least one or more sets of information from the product lot information that indicates each of the one or more of the product lots included in the manufacturing lot as indicated by the manufacturing lot information containing the manufacturing lot related information. In this case, for example, the manufacturing lot related information may be configured to include production plan information indicating the production plan for each product of one or more of the product lots included in the manufacturing lot indicated by the manufacturing lot information including the manufacturing lot related information, or may be configured to includes other one or more sets of information included in the product lot information indicating each of one or more sets of the product lots included in the manufacturing lot indicated by the manufacturing lot information including the manufacturing lot related information.

In response to the received operation, the server 30 causes display of a material consumption action related information addition image for receiving a material consumption action related information addition operation of adding material consumption action related information related to an action of consuming the material used for molding the product for adjustment of the injection molding device to the manufacturing lot information indicating the selected target manufacturing lot from one or more sets of the manufacturing lot information stored in the server 30. Hereinafter, for convenience of description, the above described action is referred to as a material consumption action. Here, material consumption actions are, for example, purging of material, trial shots by the injection molding device, and the like, but are not limited to these. Hereinafter, as an example, a case where the material consumption action is either of two actions, that is, purging of material or a trial shot by the injection molding device, will be described. It should be noted that purging of the material may be referred to as discarding material and is, for example, an action performed to prepare for loading another type of material put into the injection molding device, that is, to adjust the injection molding device. The trial shot by the injection molding device may be referred to as a dummy shot by the injection molding device, and is, for example, an action performed for adjustment of various setting values set in the injection molding device, adjustment of a metal mold attached to the injection molding device, or the like. The material consumption action related information addition image may be an image for receiving the material consumption action related information addition operation of adding material consumption action related information related to an action of consuming the material used for molding the product for adjustment of the injection molding device to the product lot information indicating the selected target product lot from one or more sets of the product lot information stored in the server 30.

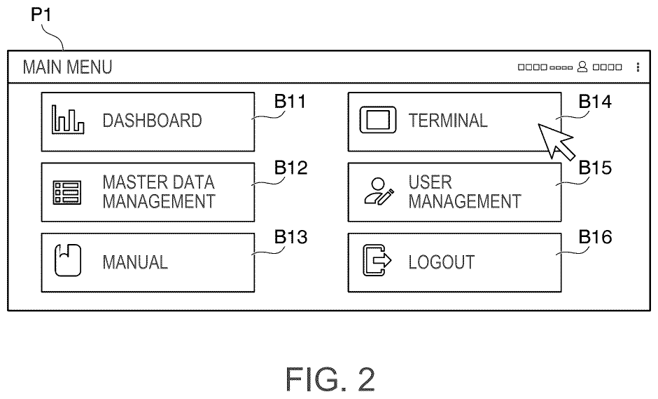

For example, the server 30 causes display of a nonconforming product information addition image by receiving an operation via a main menu image P1 as shown in FIG. 2. FIG. 2 is a diagram showing an example of the main menu image P1.

When receiving a predetermined main menu image display operation, the server 30 causes display of the main menu image P1. In the example shown in FIG. 2, the main menu image P1 includes six buttons of button B11 to button B16.

The button B11 is a button that displays a dashboard image. When a selection operation at the button B11 is received, the server 30 generates the dashboard image and causes display of the generated dashboard image. Here, the dashboard image is an image on which is displayed information necessary for the user to manage the production of the product by the injection molding device during the operation of the injection molding device designated by the user of the terminal device 40. In the present embodiment, the selection operation is a click, a tap, or similar actions, but is not limited to this.

The button B12 is a button that displays a master data management image. When a selection operation at the button B12 is received, the server 30 generates the master data management image and causes display of the generated master data management image. Here, the master data management image is an image for receiving the operation of inputting, changing, deleting, or the like of the master data described above. The server 30 can perform the generation, modification, deletion, and the like of master data in response to operations on the master data management image. When the server 30 generates the master data, the server 30 stores the generated master data. When the master data is changed, the server 30 updates the stored master data to the changed master data.

The button B13 is a button that displays a manual image. When a selection operation at the button B13 is received, the server 30 generates the manual image and causes display of the generated manual image. Here, the manual image is an image that receives the operation for displaying the manual on an operation method of the molding management system 1.

The button B14 is a button that displays a terminal image P2. When a selection operation at the button B14 is received, the server 30 generates the terminal image P2 and causes display of the generated terminal image P2. Here, the terminal image P2 is an image for receiving the operation for executing each of the various update functions included in the server 30. Certain type of update function is a function of inputting, changing, deleting, and the like of information corresponding to the type.

The button B15 is a button that displays a user management image. When a selection operation at the button B15 is received, the server 30 generates the user management image and causes display of the generated user management image. Here, the user management image is an image for receiving the operation of performing inputting, changing, deleting, displaying, or the like of information relating to the user among the information stored in the server 30.

The button B16 is a button that receives an operation of logs out the terminal device 40 from the server 30. When a selection operation at the button B16 is received, the server 30 logs out the terminal device 40.

Note that in the present embodiment, the description of each of the dashboard image, the master data management image, the manual image, and the user management image will be omitted.

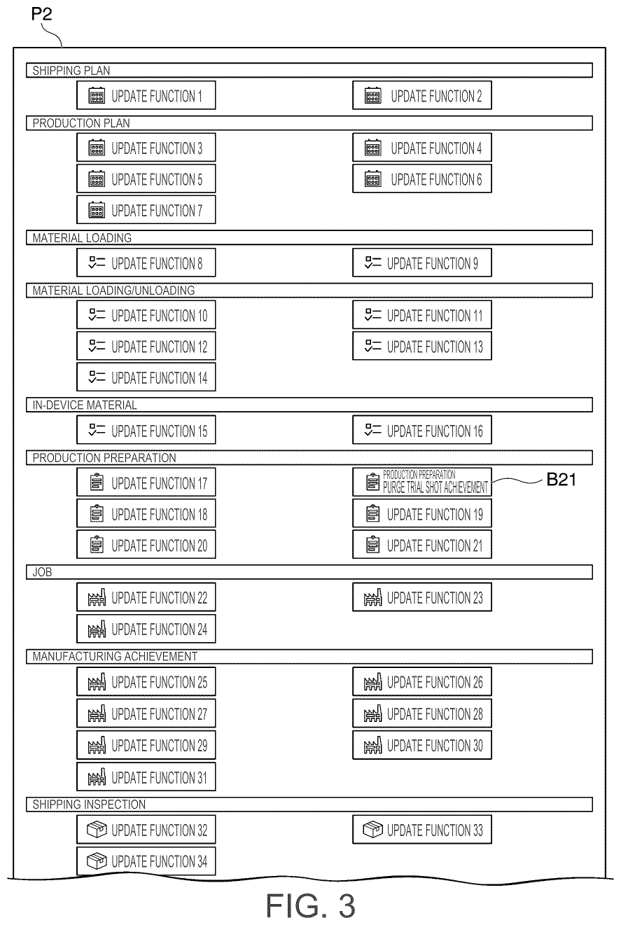

FIG. 3 is a diagram showing an example of the terminal image P2. As shown in FIG. 3, the terminal image P2 includes a button for receiving the operation for executing each of the plurality of update functions. One button among such buttons is a button B21.

The button B21 is a button that receives an operation to display the material consumption action related information addition image P3, which is an example of the material consumption action related information addition image. When a selection operation at the button B21 is performed, the server 30 generates the material consumption action related information addition image P3 and causes display of the generated material consumption action related information addition image P3.

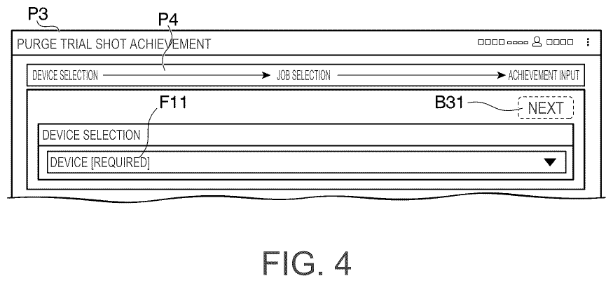

FIG. 4 is a diagram showing an example of the material consumption action related information addition image P3. Here, the state of the material consumption action related information addition image P3 shown in FIG. 4 is the initial state of the material consumption action related information addition image P3. The initial state of the material consumption action related information addition image P3 includes a target injection molding device designation image P4 for receiving an operation to designate a desired injection molding device as the target injection molding device to be subjected to the material consumption action. Note that the material consumption action related information addition image P3 may be configured to include another GUI.

In the example shown in FIG. 4, the target injection molding device designation image P4 includes, for example, an input field F11 and a button B31. Note that the target injection molding device designation image P4 may be configured to include another GUI instead of one or both of these, or in addition to both of these. Hereinafter, as an example, a case where the target injection molding device designation image P4 is one of the images included in the material consumption action related information addition image P3 will be described. In this case, the function, the GUI, or the like of the target injection molding device designation image P4 is also the function, the GUI, or the like of the material consumption action related information addition image P3.

The input field F11 is a field in which is input the injection molding device identification information that identifies the injection molding device designated by the user as the target injection molding device. In FIG. 4, “DEVICE”, which is a character string superimposed on the input field F11, is a character string for indicating to the user that the information to be input to the input field F11 is the injection molding device identification information. In the example shown in FIG. 4, nothing is input to the input field F11. Note that the injection molding device identification information to the input field F11 may be performed by selecting the injection molding device identification information from a pull-down menu or may be performed by direct input using an input device such as a keyboard.

The button B31 is a button that receives an operation of confirming the injection molding device identification information input to the input field F11 as the injection molding device identification information for identifying the target injection molding device and displaying a target manufacturing lot selection operation reception image P5. Here, the target manufacturing lot selection operation reception image P5 is an image for receiving a selection operation of selecting a desired manufacturing lot as the target manufacturing lot from one or more of the manufacturing lots, including a product lot of a product molded by the target injection molding device. When a selection operation at the button B31 is performed, the server 30 determines the injection molding device identification information input to the input field F11 as the injection molding device identification information that identifies the target injection molding device. Then, the server 30 deletes the display of the target injection molding device designation image P4 on the material consumption action related information addition image P3 and causes display of the target manufacturing lot selection operation reception image P5 on the material consumption action related information addition image P3. Here, in a case where a predetermined first gray-out condition is satisfied, the server 30 grays out the button B31 and does not accept a selection operation at the button B31. On the other hand, when the first gray-out condition is not satisfied, the server 30 cancels the gray-out of the button B31 and accepts the selection operation at the button B31. By such gray-out, the server 30 can suppress erroneous operations by the user. The first gray-out condition is, for example, a condition including condition 1A below.

Condition 1A: The injection molding device identification information is not entered to the input field F11.

When the condition 1A is satisfied, the server 30 determines that the first gray-out condition is satisfied. On the other hand, when the condition 1A is not satisfied, the server 30 determines that the first gray-out condition is not satisfied.

Here, in the example shown in FIG. 4, as described above, the injection molding device identification information is not input to the input field F11. Therefore, in the above example, the button B31 is grayed out.

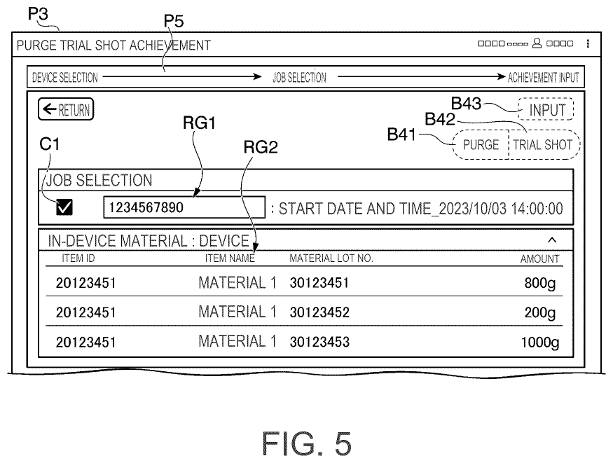

FIG. 5 is a diagram showing an example of the target manufacturing lot selection operation reception image P5 displayed by a selection operation at the button B31 shown in FIG. 4. Note that the server 30 may be configured to cause display of the target manufacturing lot selection operation reception image P5 in a pop-up manner, may be configured to cause display of the target manufacturing lot selection operation reception image P5 within the material consumption action related information addition image P3, may be configured to cause display of the target manufacturing lot selection operation reception image P5 in a separate window, or may be configured to cause display of the target manufacturing lot selection operation reception image P5 by another method. However, hereinafter, as an example, a case will be described in which the target manufacturing lot selection operation reception image P5 is one of the images included in the material consumption action related information addition image P3, even if the target manufacturing lot selection operation reception image P5 is displayed by any of these methods. In this case, the function, the GUI, or the like of the target manufacturing lot selection operation reception image P5 is also the function, the GUI, or the like of the material consumption action related information addition image P3.

The target manufacturing lot selection operation reception image P5 includes a manufacturing lot list display region RG1, a material lot information list display region RG2, a button B41, a button B42, and a button B43. Note that the target manufacturing lot selection operation reception image P5 may be configured to include another GUI instead of a part or all of these, or in addition to all of these.

The manufacturing lot list display region RG1 is a region where a list is displayed of one or more of the manufacturing lots, which include each of the product lots of the products molded by the target injection molding device. More specifically, in the manufacturing lot list display region RG1, a list of manufacturing lot identification information that identifying each of the one or more of the manufacturing lots is displayed as a list of one or more sets of the manufacturing lots. In the example shown in FIG. 5, only “1234567890” is displayed in the manufacturing lot list display region RG1. This is because, in the present example, the manufacturing lot including the product lot of the product molded by the target injection molding device is only the manufacturing lot identified by “1234567890”.

When certain manufacturing lot identification information is displayed, a checkbox for receiving an operation of selecting the manufacturing lot identification information is displayed in the manufacturing lot list display region RG1 accompanying the manufacturing lot identification information. For example, a checkbox C1 shown in FIG. 5 is a checkbox for receiving an operation of selecting “1234567890”, which is the manufacturing lot identification information displayed in the manufacturing lot list display region RG1. In the example shown in FIG. 5, the manufacturing lot identification information “1234567890” is selected via the checkbox C1. The server 30 identifies the manufacturing lot indicated by the manufacturing lot identification information selected via the checkbox C1 as the target manufacturing lot. Note that in the manufacturing lot list display region RG1 may be configured to display a checkbox for receiving an operation of selecting all the manufacturing lot identification information displayed in the manufacturing lot list display region RG1. By this, the server 30 can reduce the time and effort required for the user to select the manufacturing lot identification information. Hereinafter, for convenience of description, an operation of selecting the manufacturing lot identification information via the checkbox will be referred to as a manufacturing lot selection operation. Note that the target manufacturing lot selection operation reception image P5 may be configured without including the manufacturing lot list display region RG1. In this case, the server 30 does not identify the target manufacturing lot. However, even in this case, the server 30 can identify the manufacturing lot corresponding to the target manufacturing lot based on the target injection molding device, the date and time that the material consumption action related information is added to the manufacturing lot information, and the like. The selection of a certain lot may be referred to as the selection of the lot information indicating the lot.

When certain manufacturing lot identification information is displayed, with respect to the product of the product lot included in the manufacturing lot identified by the manufacturing lot identification information, information indicating the date and time when the process most recently performed was started is displayed in the manufacturing lot list display region RG1 in association with the manufacturing lot identification information. In the example shown in FIG. 5, “START DATE AND TIME_2023/10/03 14:00:00” indicating 14:00 on Oct. 3, 2023 is displayed as information accompanying the manufacturing lot identification information “1234567890” displayed in the manufacturing lot list display region RG1.

The material lot information list display region RG2 is a region in which is displayed a list of the material lot information, which indicates the material lots of materials put into the target injection molding device, that is, materials used for molding products by the target injection molding device. Here, as described above, the material lot information indicating the material lot of a certain material includes, for example, the material identification information for identifying the material, the material name information indicating the name of the material, the material lot identification information for identifying the material lot, and the material remaining amount information indicating the remaining amount of the material. In the example shown in FIG. 5, the material identification information is indicated by “ITEM ID”, the material name information is indicated by “ITEM NAME”, the material lot identification information is indicated by “MATERIAL LOT NO.”, and the material remaining amount information is indicated by “AMOUNT”. In the above example, three sets of material lot information are displayed in the material lot information list display region RG2. For example, the topmost material lot information displayed in the material lot information list display region RG2 shown in FIG. 5 includes “20123451”, which is the material identification information, “MATERIAL 1”, which is the material name information, “30123451”, which is the material lot identification information, and “800 g”, which is the material remaining amount information. Note that the “800 g” is the material remaining amount information indicating 800 g. That is, in the present example, by viewing the material lot information list display region RG2, the user can understand that a total of 2000 g of the material identified by “20123451” was put into the target injection molding device from each of the three different material lots. Note that the material lot information list display region RG2 may be a region in which is displayed a list of the material lot information, which indicates the material lots of the materials stored in a predetermined storage location such as a shelf.

The button B41 is a button that receives an operation of selecting purging of material as the material consumption action. When a selection operation at the button B41 is performed, the server 30 specifies that the material consumption action is purging of material and changes a display mode of the button B41 to a display mode indicating that purging of material is selected as the material consumption action. When the selection operation at the button B41 is repeatedly performed, the server 30 causes the display mode of the button B41 to change between the display mode indicating that purging of material is selected as the material consumption action and a display mode indicating that purging of material is not selected as the material consumption action every time the selection operation at the button B41 is performed. When the server 30 changes the display mode of the button B41 to the display mode indicating that purging of material is selected as the material consumption action, the server 30 grays out the button B42 and does not accept a selection operation at the button B42. Hereinafter, for convenience of description, the display mode indicating that purging of material is selected as the material consumption action will be referred to as a purge selection display mode and the display mode indicating that purging of material is not selected as the material consumption action will be referred to as a purge non-selection display mode. The button B41 is an example of a material use action type selection image.

The button B42 is a button that receives an operation of selecting a trial shot by the target injection molding device as the material consumption action. When a selection operation at the button B42 is performed, the server 30 specifies that the material consumption action is a trial shot by the target injection molding device and changes the display mode of the button B42 to a display mode indicating that a trial shot by the target injection molding device is selected as the material consumption action. When the selection operation at the button B42 is repeatedly performed, the server 30 causes the display mode of the button B42 to change between the display mode indicating that a trial shot by the target injection molding device is selected as the material consumption action and a display mode indicating that a trial shot by the target injection molding device is not selected as the material consumption action every time the selection operation to the button B42 is performed. When the server 30 changes the display mode of the button B42 to the display mode indicating that a trial shot by the target injection molding device is selected as the material consumption action, the server 30 grays out the button B41 and does not accept a selection operation at the button B41. Hereinafter, for convenience of description, the display mode indicating that a trial shot by the target injection molding device is selected as the material consumption action will be referred to as a trial shot selection display mode, and the display mode indicating that a trial shot by the target injection molding device is not selected as the material consumption action will be referred to as a trial shot non-selection display mode. The button B42 is an example of a material use action type selection image.

The button B43 is a button that receives an operation of displaying the material consumption action related information addition image. When the display mode of the button B41 is the purge non-selection display mode and the display mode of the button B42 is the trial shot non-selection display mode, the server 30 grays out the button B43 and does not accept a selection operation at the button B43. When the display mode of the button B41 is the purge selection display mode, the server 30 cancels the gray-out of the button B43 and accepts a selection operation at the button B43. Then, when the selection operation at the button B43 is performed in the above case, the server 30 deletes the display of the target manufacturing lot selection operation reception image P5 and causes display of the purge related information input image P6, which is an example of the material consumption action related information input image. On the other hand, when the display mode of the button B42 is the trial shot selection display mode, the server 30 cancels the gray-out of the button B43 and accepts a selection operation at the button B43. Then, when the selection operation at the button B43 is performed in the above case, the server 30 deletes the display of the target manufacturing lot selection operation reception image P5 and causes display of the trial shot related information input image P7, which is an example of the material consumption action related information input image.

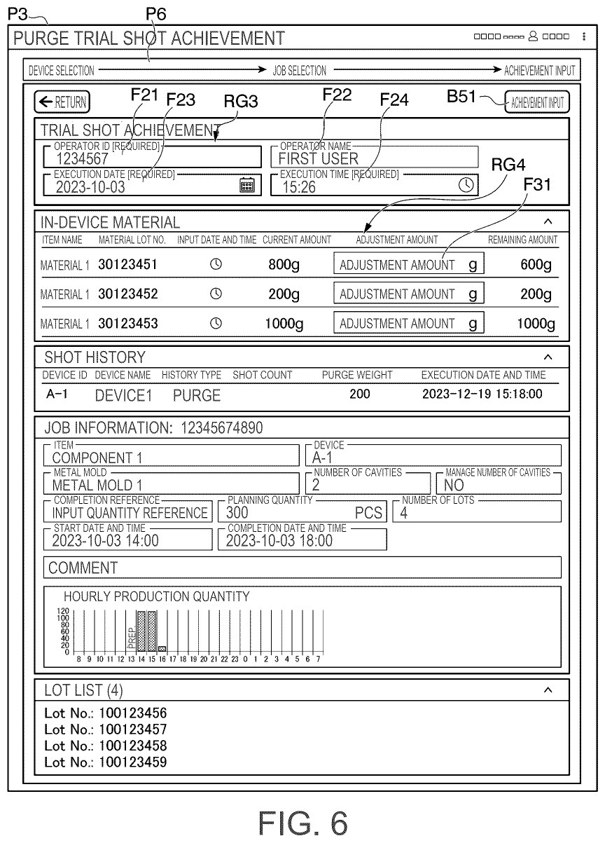

FIG. 6 is a diagram showing an example of the purge related information input image P6. Note that the server 30 may be configured to cause display of the purge related information input image P6 in a pop-up manner, may be configured to cause display of the purge related information input image P6 within the material consumption action related information addition image P3, may be configured to cause display of the purge related information input image P6 in a separate window, or may be configured to cause display of the purge related information input image P6 by another method. However, hereinafter, as an example, even when the purge related information input image P6 is displayed by any of these methods, a case where the purge related information input image P6 is one of the images included in the material consumption action related information addition image P3 will be described. In this case, the function, the GUI, or the like of the purge related information input image P6 is also the function, the GUI, or the like of the material consumption action related information addition image P3.

The purge related information input image P6 includes, for example, a purge related information input region RG3, a purge amount designation region RG4, and a button B51. Note that the purge related information input image P6 may include another GUI instead of a part or all of these, or in addition to all of these. In the example shown in FIG. 6, the purge related information input image P6 further includes a region in which material purge history information (to be described later) is displayed as information indicating the history of past purges performed in the target injection molding device, a region in which various kinds of information included in the product lot related information included in the product lot information indicating each of the product lots included in the target manufacturing lot is displayed, a region in which a graph showing the production plan for the target manufacturing lot is displayed, and a region in which a list of the lot identification information that identifies each of the one or more of the product lots included in the target manufacturing lot is displayed. Here, in the purge related information input image P6, a region where the material purge history information is displayed is the region indicated by the character string “SHOT HISTORY”. In the present embodiment, a detailed description of these four regions will be omitted.

The purge related information input region RG3 includes input field F21 to input field F24. The purge related information input region RG3 may include another GUI instead of a part or all of these, or in addition to all of these.

The input field F21 is a field in which is input user identification information that identifies a user who caused the target injection molding device to the perform purging or the user who is going to cause the target injection molding device to perform purging. In FIG. 6, “OPERATOR ID”, which is a character string superimposed on the input field F21, is a character string for indicating to the user that the information to be input to the input field F21 is the user identification information. By default, for example, the user identification information of a user who is logging in to the server 30 is input to the input field F21. The method of determining the user identification information by the server 30 may be a known method or a method to be developed. In the example shown in FIG. 6, “1234567” is input to the input field F21 as the user identification information to be input by default. Note that the input of user identification information to the input field F21 other than the input of the default user identification information may be performed by selecting the user identification information from a pull-down menu or may be performed by direct input using the input device such as the keyboard.

The input field F22 is a field in which is input a user name information that indicates the name of the user who caused the target injection molding device to perform the purging or the user who is going to cause the target injection molding device to perform the purging. In FIG. 6, “OPERATOR NAME”, which is a character string superimposed on the input field F22, is a character string for indicating to the user that the information to be input to the input field F22 is the user name information. By default, for example, the user name information of a user who is logging in to the server 30 is input to the input field F22. The method of determining the user name information by the server 30 may be a known method or a method to be developed. In the example shown in FIG. 6, “FIRST USER” is input to the input field F22 as the user name information to be input by default. Note that the input of the user name information to the input field F22 other than the input of the default user name information may be performed by selecting the user name information from a pull-down menu or may be performed by direct input using the input device such as the keyboard.

The input field F23 is a field in which is input purge date information that indicates the date when the target injection molding device was caused to perform the purging or the date when the target injection molding device is going to be caused to perform the purging. In FIG. 6, “EXECUTION DATE”, which is a character string superimposed on the input field F23, is a character string for indicating to the user that the information to be input to the input field F23 is the purge date information. In the example shown in FIG. 6, “2023 Oct. 3” indicating Oct. 3, 2023 is input as the purge date information to the input field F23. Note that the input of the purge date information to the input field F23 may be performed by selection using an image showing a calendar or may be performed by direct input using the input device such as the keyboard.

The input field F24 is a field in which is input purge time information that indicates the time when the target injection molding device was caused to perform the purging or the time when the target injection molding device will be caused to perform the purging. In FIG. 6, “EXECUTION TIME”, which is a character string superimposed on the input field F24, is a character string for indicating to the user that the information to be input to the input field F24 is the purge time information. In the example shown in FIG. 6, “15:26” indicating 15:26 is input as the purge time information to the input field F24. Note that the purge time information may be input to the input field F24 may be performed by selection using an image indicating a clock or may be performed by direct input using the input device such as the keyboard.

The purge amount designation region RG4 is a region in which is displayed a list of material lot information, which was displayed in the material lot information list display region RG2 of the target manufacturing lot selection operation reception image P5. However, in the example shown in FIG. 6, three information from the material lot information, specifically the material name information, material lot identification information, and material remaining amount information, are displayed in the purge amount designation region RG4. In the above example, the purge amount designation region RG4 displays, in association each set of the material lot information, an input field to which the purge amount information indicating the amount of material to be purged is input, and post purge material remaining amount information indicating the amount obtained by subtracting the amount indicated by the purge amount information input to the input field from the remaining amount indicated by the material remaining amount information. The input field F31 shown in FIG. 6 is an example of the input field.

The input field F31 is a field that displays in association with the material lot information displayed at the uppermost stage in the purge amount designation region RG4 shown in FIG. 6 and is a field in which is input the purge amount information that indicates the amount of the material to be purged as indicated by the material lot information. When the purge amount information is input to the input field F31, the server 30 calculates the amount obtained by subtracting the amount indicated by the purge amount information input to the input field F31 from the remaining amount indicated by the material remaining amount information included in the material lot information. After calculating the amount, the server 30 generates the post purge material remaining amount information indicating the calculated amount and causes display of the generated post purge material information to the right side of the input field F31. By this, the user can easily confirm whether or not the remaining amount of the material after the purging reaches the desired remaining amount by viewing the post purge material remaining amount information. By default, for example, the purge amount information indicating the same amount as the material remaining amount information is input to the input field F31. This is because, when the purge of the material is performed, the purge of the material is often performed so that the remaining amount of the material becomes zero. By this, the server 30 can reduce the labor required for the user to input the purge amount information. By default, for example, the input field F31 may have nothing entered in it. In the example shown in FIG. 6, nothing is input to the input field F31. Therefore, in the above example, “800 g” indicating the same amount as the amount indicated by “800 g”, which is the material remaining amount information, is displayed in association with the lot information as the post purge material remaining amount information. Note that the input of the purge amount information to the input field F31 other than the input of the default purge amount information may be performed by direct input using the input device such as the keyboard or may be performed by another method. Hereinafter, for convenience of description, an input field in which the purge amount information is input, such as the input field F31 in the purge amount designation region RG4, is referred to as a purge amount input field. The purge amount input field is an example of the material consumption information input image.

The button B51 is a button that receives an operation of confirming the addition of purge related information, which is an example of material consumption action related information, to target manufacturing lot information. When the selection operation at the button B51 is performed, the server 30 generates the material purge history information in which the material lot identification information included in the material lot information is associated with the purge amount information input to the purge amount input field displayed in association with the material lot information for each set of material lot information displayed in the purge amount designation region RG4. Then, the server 30 generates purge related information including the material purge history information generated for each material lot and the information input in each of the input field F21 to the input field F24. Here, the material purge history information includes the purge amount information for each of the material lot information displayed in the purge amount designation region RG4. The purge amount information for a certain material lot information is the purge amount information input to the purge amount input field displayed in association with the material lot information. The purge amount information included in the material purge history information is nothing but information that indicates the amount of material consumed by the purging. After generating the purge related information, the server 30 stores the generated purge related information in association with the manufacturing lot identification information included in the target manufacturing lot information indicating the target manufacturing lot selected in the target manufacturing lot selection operation reception image P5. By this, the server 30 adds the purge related information to the manufacturing lot information. As a result, when purging of material is performed by the injection molding device, the server 30 can suppress the occurrence of a difference between the actual manufacturing lot and the manufacturing lot on the molding management system. Note that the server 30 may be configured to, in association with the addition of the purge related information to the manufacturing lot information, update, for each set of material lot information displayed in the purge amount designation region RG4, the material remaining amount information included in the material lot information as information indicating a value obtained by subtracting the amount indicated by the purge amount information input to the purge amount input field displayed in association with the material lot information from the remaining amount indicated by the material remaining amount information included in the material lot information. In this case, the server 30 can allow the user to manage the inventory of the material.

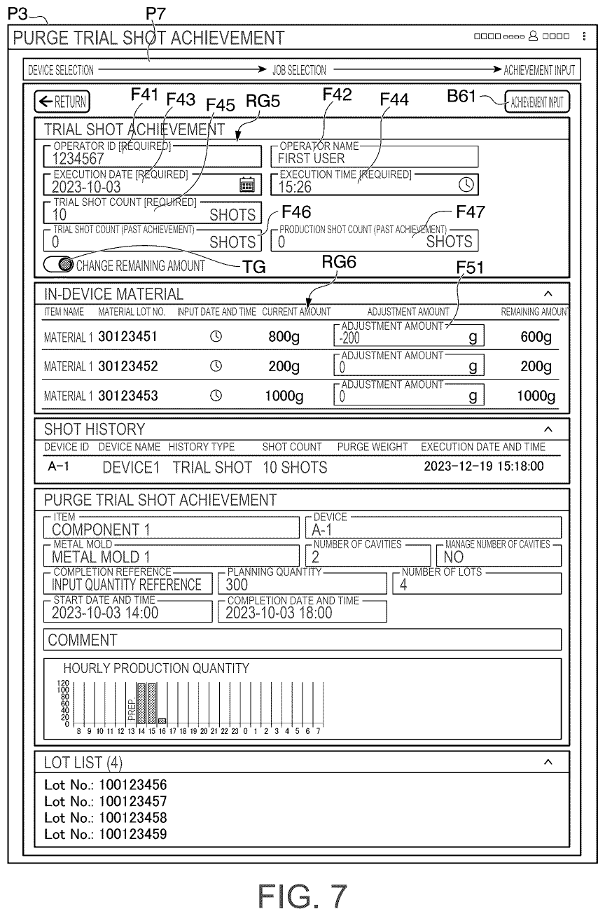

On the other hand, FIG. 7 is a diagram showing an example of the trial shot related information input image P7. Note that the server 30 may be configured to cause display of the trial shot related information input image P7 in a pop-up manner, may be configured to cause display of the trial shot related information input image P7 within the material consumption action related information addition image P3, may be configured to cause display of the trial shot related information input image P7 in a separate window, or may be configured to cause display of the trial shot related information input image P7 by another method. However, hereinafter, as an example, even when the trial shot related information input image P7 is displayed by any of these methods, a case will be described in which the trial shot related information input image P7 is one of images included in the material consumption action related information addition image P3. In this case, the function, the GUI, or the like of the trial shot related information input image P7 is also the function, the GUI, or the like of the material consumption action related information addition image P3.

The trial shot related information input image P7 includes, for example, a trial shot related information input region RG5, a trial shot use amount designation region RG6, and a button B61. Note that the trial shot related information input image P7 may include another GUI instead of a part or all of these, or in addition to all of these. In the example shown in FIG. 7, the trial shot related information input image P7 further includes a region in which is displayed the trial shot history information (to be described later) as information indicating the history of past trial shots performed in the target injection molding device, a region in which is displayed various kinds of information included in the product lot related information indicating each of the product lots included in the target manufacturing lot, a region in which is displayed a graph showing the production plan for the target manufacturing lot, and a region in which is displayed a list of the lot identification information that identifies each of one or more of the product lots included in the target manufacturing lot. Here, in the trial shot related information input image P7, a region where the trial shot history information is displayed is the region indicated by the character string “SHOT HISTORY”. In the present embodiment, the description of these four areas will be omitted.

The trial shot related information input region RG5 includes an input field F41 to an input field F45, a display field F46, a display field F47, and a toggle switch TG. The trial shot related information input region RG5 may include another GUI instead of a part or all of these, or in addition to all of these.

The input field F41 is a field in which is input the user identification information that identifies the user who caused the target injection molding device to perform the trial shot or the user who is going to cause the target injection molding device to perform the trial shot. In FIG. 7, “OPERATOR ID”, which is a character string superimposed on the input field F41, is a character string for indicating to the user that the information to be input to the input field F41 is the user identification information. By default, for example, the user identification information of a user who is logging in to the server 30 is input to the input field F41. The method of determining the user identification information by the server 30 may be a known method or a method to be developed. In the example shown in FIG. 7, “1234567” is input to the input field F41 as the user identification information to be input by default. Note that the input of user identification information to the input field F41 other than the input of the default user identification information may be performed by selecting the user identification information from a pull-down menu or may be performed by direct input using the input device such as the keyboard.

The input field F42 is a field in which is input the user name information that indicates the name of the user who caused the target injection molding device to perform the trial shot or the user who is going to cause the target injection molding device to perform the trial shot. In FIG. 7, “OPERATOR NAME”, which is a character string superimposed on the input field F42, is a character string for indicating to the user that the information to be input to the input field F42 is the user name information. By default, for example, the user name information of a user who is logging in to the server 30 is input to the input field F42. The method of determining the user name information by the server 30 may be a known method or a method to be developed. In the example shown in FIG. 7, “FIRST USER” is input to the input field F42 as the user name information to be input by default. Note that the input of the user name information to the input field F42 other than the input of the default user name information may be performed by selecting the user name information from a pull-down menu or may be performed by direct input using the input device such as the keyboard.

The input field F43 is a field in which is input trial shot date information that indicates the date when the target injection molding device was caused to perform a trial shot or the date when the target injection molding device is going to be caused to perform a trial shot. In FIG. 7, “EXECUTION DATE”, which is a character string superimposed on the input field F43, is a character string for indicating to the user that the information to be input to the input field F43 is the trial shot date information. In the example shown in FIG. 7, “2023 Oct. 3” indicating Oct. 3, 2023, is input as the trial shot date information to the input field F43. Note that the input of the trial shot date information to the input field F43 may be performed by selection using an image showing a calendar or may be performed by direct entry using the input device such as the keyboard.

The input field F44 is a field in which is input the trial shot time information that indicates the time when the target injection molding device was caused to perform the trial shot or the time when the target injection molding device is going to be caused to perform the trial shot. In FIG. 7, “EXECUTION TIME”, which is a character string superimposed on the input field F44, is a character string for indicating to the user that the information to be input to the input field F44 is the trial shot time information. In the example shown in FIG. 7, “15:26” indicating 15:26 is input as the trial shot time information to the input field F44. Note that the input of the trial shot time information to the input field F44 may be performed by selection using an image showing a clock or may be performed by direct input using the input device such as the keyboard.

The input field F45 is a field in which is input the trial shot count information that indicates the number of shots that were made by the target injection molding device as trial shots or the number of shots that are going to made by the target injection molding device as trial shots. In FIG. 7, “TRIAL SHOT COUNT”, which is a character string superimposed on the input field F45 is a character string for indicating to the user that the information to be input to the input field F45 is the trial shot count information. In the example shown in FIG. 7, “10” indicating 10 shots is input as the trial shot count information to the input field F45. Note that the input of the trial shot count information to the input field F45 may be performed by selecting the trial shot count information from a pull-down menu or may be performed by direct input using the input device such as the keyboard.

The display field F46 is a field in which is displayed the trial shot count information included in the trial shot related information of the manufacturing lot information indicating the target manufacturing lot at the time when the trial shot related information input image P7 is displayed. In FIG. 7, “TRIAL SHOT COUNT (PAST ACHIEVEMENT)”, which is a character string superimposed on the display field F46 is a character string for indicating to the user that the information to be displayed on the display field F46 is the trial shot count information. In the example shown in FIG. 7, “0” indicating 0 shots is displayed in the display field F46 as the trial shot count information. For example, when the manufacturing lot information indicating the target manufacturing lot does not include the trial shot related information, the server 30 causes display of “0” indicating 0 shots in the display field F46 as the trial shot count information.

The display field F47 is a field in which is displayed information indicating, as product molding count information indicating the number of shots performed by the target injection molding device until now, the number of all non-overlapping shot identification information among the shot identification information included in the manufacturing lot information indicating the target manufacturing lot at the time when the trial shot related information input image P7 is displayed. In FIG. 7, “PRODUCTION SHOT COUNT (PAST ACHIEVEMENT)”, which is a character string superimposed on the display field F47 is a character string for indicating to the user that the information to be displayed on the display field F47 is the product molding count information. In the example shown in FIG. 7, “0” indicating 0 shots is displayed in the display field F47 as the product molding count information. For example, when the product related information indicating the target manufacturing lot does not include the manufacturing lot information, the server 30 causes display of “0” indicating 0 shots in the display field F47 as the product molding count information.

The toggle switch TG is a toggle switch that receives an operation of selecting whether or not to change the remaining amount indicated by the material remaining amount information included in the material lot information. When the server 30 receives an operation selecting to change the remaining amount indicated by the material remaining amount information included in the material lot information, the server 30 changes the display mode of toggle switch TG to a display mode indicating that the change of the remaining amount is selected. On the other hand, when the server 30 receives an operation selecting not to change the remaining amount indicated by the material remaining amount information included in the material lot information, the server 30 changes the display mode of the toggle switch TG to a display mode indicating that not to change the remaining amount is selected. These display modes of the toggle switch TG may be any mode as long as it is a display mode that allows one to distinguish whether or not the selection made by the toggle switch TG changes the remaining amount indicated by the material remaining amount information contained in the material lot information. Here, the toggle switch TG shown in FIG. 7 indicates that it is selected to change the remaining amount. Hereinafter, for convenience of description, the display mode indicating that changing the remaining amount is selected will be referred to as a trial shot use amount reflecting display mode, and the display mode indicating that not changing the remaining amount is selected will be referred to as a trial shot use amount non-reflecting display mode.

The trial shot use amount designation region RG6 is a region in which is displayed a list of material lot information, which was displayed in the material lot information list display region RG2 of the target manufacturing lot selection operation reception image P5. However, in the example shown in FIG. 7, the trial shot use amount designation region RG6 displays three information, namely the material name information, the material lot identification information, and the material remaining amount information, among the information included in the material lot information. In the above example, in the trial shot use amount designation region RG6 is displayed, in association with each piece of material lot information, an input field to which is input trial shot use amount information indicating the amount of the material to be used by the trial shot and post trial shot material remaining amount information indicating the amount obtained by subtracting the amount indicated by the trial shot use amount information input to the input field from the remaining amount indicated by the material remaining amount information. The input field F51 shown in FIG. 7 is an example of the input field.

The input field F51 is a field that is displayed in association with the material lot information at the uppermost stage in the trial shot use amount designation region RG6 shown in FIG. 7 and is a field in which is input the trial shot use amount information that indicates the amount to be used in a trial shot of material as indicated by the material lot information. However, a negative value is input to the input field F51. This is because the trial shot use amount information indicates the amount by which the material will be consumed due to the trial shot. When the trial shot use amount information is input to the input field F51, the server 30 calculates the amount obtained by adding the amount indicated by the trial shot use amount information input to the input field F51 to the remaining amount indicated by the material remaining amount information included in the material lot information. After calculating the amount, the server 30 generates post trial shot material remaining amount information indicating the calculated amount and causes display of the generated post trial shot material remaining amount information to the right side of the input field F51. By this, the user can easily confirm whether or not the remaining amount of material after the trial shot reaches the desired remaining amount by viewing the post trial shot material remaining amount information. By default, in the input field F51 is input, for example, the amount obtained by multiplying the number of times indicated by the trial shot count information input to the input field F45 by the amount indicated by the information included in the master data indicating the amount of the material used per shot. In the example shown in FIG. 7, “−200 g” indicating −200 g is input as the trial shot use amount information to the input field F51. This is because, among the information included in the master data, the amount indicated by the information showing the amount of the material used per shot is 20 g. As a result, in the above example, “600 g” indicating the same amount as the amount indicated by “600 g”, which is the material remaining amount information, is displayed in association with the lot information as the post trial shot material remaining amount information. Note that the input of the trial shot use amount information to the input field F51 other than the default input of the trial shot use amount information may be performed by direct input using the input device such as the keyboard or may be performed by another method. Hereinafter, for convenience of description, an input field in which the trial shot use amount information is input, such as the input field F51 in the trial shot use amount designation region RG6, will be referred to as a trial shot use amount input field. The value input to the trial shot use amount input field may be a positive value. In this case, when the trial shot use amount information is input to the input field F51, the server 30 calculates the amount obtained by subtracting the amount indicated by the trial shot use amount information input to the input field F51 from the remaining amount indicated by the material remaining amount information included in the material lot information. After calculating the amount, the server 30 generates post trial shot material remaining amount information indicating the calculated amount and causes display of the generated post trial shot material remaining amount information to the right side of the input field F51. The trial shot use amount input field is an example of the material consumption information input image.

The button B61 is a button that receives an operation of confirming the addition of the trial shot related information, which is an example of the material consumption action related information, to the target manufacturing lot information. When the display mode of the toggle switch TG is the trial shot use amount reflecting display mode and a selection operation at the button B61 is performed, the server 30 changes the remaining amount indicated by the material remaining amount information included in the material lot information to the remaining amount indicated by the post trial shot material remaining amount information displayed in association with the material lot information for each set of material lot information displayed in the trial shot use amount designation region RG6. Thereafter, the server 30 generates the trial shot history information for each set of material lot information displayed in the trial shot use amount designation region RG6, by associating the material lot identification information included in the material lot information with the trial shot use amount information input to the trial shot use amount input field displayed in association with the material lot information. Then, the server 30 generates the trial shot related information including the trial shot history information generated for each of the material lot and the information input in each of the input field F41 to the input field F45. Here, the trial shot history information includes the trial shot use amount information for each set of material lot information displayed in the trial shot use amount designation region RG6. The trial shot use amount information of certain material lot information is the trial shot use amount information input in the trial shot use amount input field displayed in association with the material lot information. The trial shot use amount information included in the trial shot history information is nothing but information that indicates the amount of material consumed by the trial shot. After generating the trial shot related information, the server 30 stores the generated trial shot related information in association with the manufacturing lot identification information included in the manufacturing lot information indicating the target manufacturing lot selected in the target manufacturing lot selection operation reception image P5. By this, the server 30 adds the trial shot related information to the target manufacturing lot information. As a result, when the material is used for the trial shot by the injection molding device, the server 30 can suppress the occurrence of a difference between the actual manufacturing lot and the manufacturing lot on the molding management system. On the other hand, when the display mode of the toggle switch TG is the trial shot use amount non-reflecting display mode and the selection operation at the button B61 is performed, the server 30 does not change the remaining amount indicated by the material remaining amount information included in the material lot information. By this, when there is no difference in the remaining amount of the material between the actual manufacturing lot and the manufacturing lot on the molding management system 1, the user can store only the history of the trial shot of the material on the molding management system 1. When the display mode of the toggle switch TG is the trial shot use amount non-reflecting display mode and the selection operation at the button B61 is performed, the server 30 generates the trial shot history information in which the material lot identification information included in the material lot information is associated with the trial shot use amount information input to the trial shot use amount input field displayed in association with the material lot information for each set of the material lot information displayed in the trial shot use amount designation region RG6. Then, the server 30 generates the trial shot related information including the trial shot history information generated for each of the material lot and the information input in each of the input field F41 to the input field F45. After generating the trial shot related information, the server 30 stores the generated trial shot related information in association with the manufacturing lot identification information included in the target manufacturing lot information indicating the target manufacturing lot selected in the target manufacturing lot selection operation reception image P5. By this, the server 30 adds the trial shot related information to the target manufacturing lot information. As a result, when the material is used for the trial shot by the injection molding device, the server 30 can suppress the occurrence of a difference between the actual manufacturing lot and the manufacturing lot on the molding management system. Note that the server 30 may be configured to, in accordance with addition of the trial shot related information to the manufacturing lot information, update the material remaining amount information included in the material lot information as information indicating a value obtained by subtracting the amount indicated by the trial shot use amount information input to the trial shot use amount input field displayed in association with the material lot information, from the remaining amount indicated by the material remaining amount information included in the material lot information for each set of material lot information displayed in the trial shot use amount designation region RG6. In this case, the server 30 can allow the user to manage the inventory of the material.

Note that the server 30 may be configured to, by accepting a predetermined operation, cause display of the correspondence relationship reception image P8 for associating the shot identification information for identifying the shot in which the product is molded with the material consumption action related information.

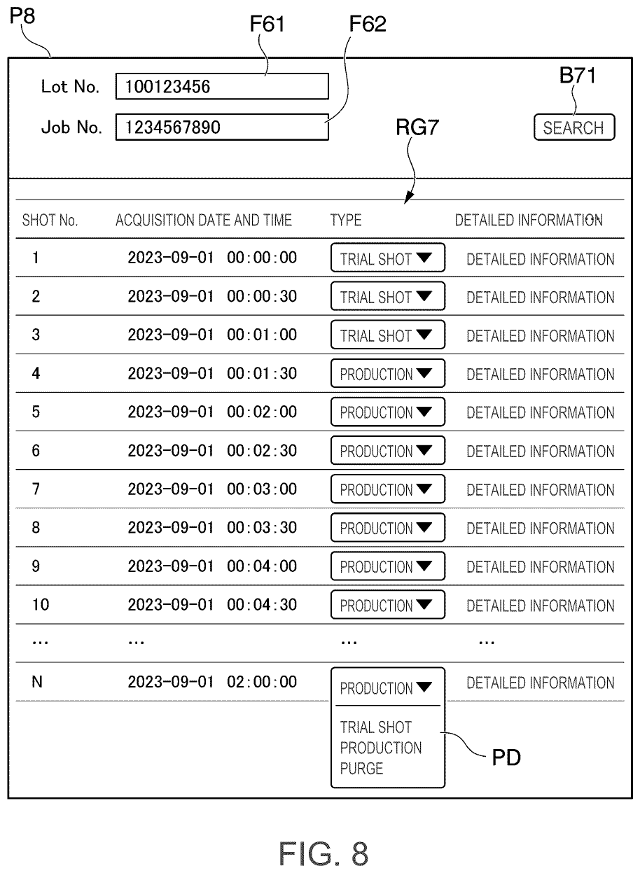

FIG. 8 is a diagram showing an example of the correspondence relationship reception image P8.

The correspondence relationship reception image P8 includes, for example, an input field F61, a display field F62, a button B71, and a product related information list display region RG7. Note that the correspondence relationship reception image P8 may be configured to include another GUI instead of a part or all of these, or in addition to all of these.

The input field F61 is a field in which is input the product lot identification information, which identifies the product lot among the product lots included in the target manufacturing lot, that were molded by the injection molding device that performed the material consumption action or the injection molding device that is going to perform the material consumption action. In FIG. 8, “LOT NO.”, which is a character string displayed in association with the input field F61, is a character string for indicating to the user that the information to be input to the input field F61 is the product lot identification information. In the example shown in FIG. 8, “100123456” is input to the input field F61 as the product lot identification information. Note that the input of the product lot identification information to input field F61 may be performed by selecting the product lot identification information from a pull-down menu that includes the product lot identification information for identifying each product lot within the target manufacturing lot or may be performed by direct input using the input device such as the keyboard.

The display field F62 is a field in which is displayed the manufacturing lot identification information for identifying the target manufacturing lot. In FIG. 8, “JOB NO.”, which is a character string displayed in association with the display field F62, is a character string indicating to the user that the information to be displayed on the display field F62 is the manufacturing lot identification information. In the example shown in FIG. 8, “1234567890” is displayed in the display field F62 as the manufacturing lot identification information.

The button B71 is a button that receives an operation of displaying a list of the product related information included in the product lot related information of the product lot information indicating the product lot identified by the product lot identification information input to the input field F61 in the product related information list display region RG7. When a selection operation at the button B71 is performed, the server 30 displays the list of product related information in the product related information list display region RG7.

The product related information list display region RG7 is a region in which a list is displayed of one or more sets of product related information included in the product lot information, which indicates the product lot identified by the product lot identification information input to the input field F61. Hereinafter, for convenience of description, the product lot will be referred to as the target product lot. In the example shown in FIG. 8, the product related information for each of the N products of the target product lot is displayed in the product related information list display region RG7. Here, in the example shown in FIG. 8, N is an integer of 11 or more. In the above example, each piece of the product related information includes the shot identification information, molding date and time information indicating the date and time when the product was molded, and detailed information that is information details of the related to the product. Note that in the above example, the shot identification information is indicated by “SHOT NO.”. In the above example, the molding date and time information is indicated by “ACQUISITION DATE AND TIME”. In the above example, the pull-down menu is indicated by “TYPE”. Further, in the above example, the detailed information is indicated by “DETAILED INFORMATION”. Each set of product related information is accompanied and displayed by a pull-down menu from which can be selected the material use action type information, which indicates the type of action by which the material was used in the shot identified by the shot identification information. A pull-down menu PD shown in FIG. 8 is an example of a pull-down menu in which can be selected the material use action type information indicating the type of action by which the material was used in the shot identified by the shot identification information. More specifically, the pull-down menu PD is a pull-down menu that enables selection of the material use action type information indicating the type of action by which the material was used in the shot identified by the shot identification information included in the N-th product related information among the N product related information displayed in the product related information list display region RG7. In the above example, the pull-down menu PD includes three kinds of material use action type information, that is, “TRIAL SHOT” indicating the trial shot, “PRODUCTION” indicating the molding of the product, and “PURGE” indicating the purging. By operating the pull-down menu PD, the user can select the desired material use action type information from the three sets of material use action type information included in the pull-down menu PD. The pull-down menu is an example of the material use action type selection image.

For example, in the pull-down menu of the top three sets of product related information among the N sets of product related information displayed in the product related information list display region RG7 shown in FIG. 8, “TRIAL SHOT” indicating a trial shot is selected as the material use action type information. That is, in the example shown in FIG. 8, each of the first shot to third shot is performed as a trial shot. The server 30 adds, to the product related information for each of the N sets of product related information displayed in the product related information list display region RG7 shown in FIG. 8, the material use action type information selected by the pull-down menu displayed in association with the product related information and stores it. By this, the server 30 can associate the shot identification information for identifying the shot in which the product is molded with the material consumption action related information. Note that for example, when the material use action type information is changed by such a pull-down menu, the server 30 may be configured to change the remaining amount indicated by the material remaining amount information of the material lot information, the number indicated by the production quantity information included in the product lot information, and the like according to the change of the material use action type information. The methods for making such changes may be a known method or a method to be developed. Here, such a change is useful because it leads to the ability to adjust the difference between the actual manufacturing lot and the manufacturing lot on the molding management system 1 more precisely when the movement of the product between the product lots, the coupling of the product lots, the change in the number of products in the product lot, or the like is performed. For example, when a plurality of trial shots are performed during molding of a product of a certain product lot, the plurality of trial shots may be erroneously treated as production of the product on the molding management system 1. In this case, the number of products in the product lot exceeds the upper limit, resulting in the creation of a surplus product lot. In such a case, by combining the surplus product lot with the product lot, reducing the number of products of the product lot, and inputting the reduced number of products as the number of trial shots, it is possible to suppress the occurrence of a difference between the actual manufacturing lot and the manufacturing lot in the molding management system 1.

Note that the display of the correspondence relationship reception image P8 may be performed from any of the images described above. The correspondence relationship reception image P8 may be an image included in the material consumption action related information addition image P3 or may be an image not included in the material consumption action related information addition image P3.

The server 30, which is capable of causing the terminal device 40 to display an image such as the material consumption action related information addition image P3 as described above, is, for example, a workstation, a desktop PC, a notebook PC, or the like, but is not limited to these. The server 30 may be configured to be integral with the information process device 20.

The server 30 is communicatively connected to the information process device 20 by communication via a wire or wireless. The communication network connecting the server 30 and information process device 20 may be, for example, the LAN in the facility where the plurality of managed devices 10 is installed, may be the Internet, may be a mobile communication network, or may be another communication network. Hereinafter, as an example, a case where the communication network connecting the server 30 and the information process device 20 is the Internet will be described. In this case, the server 30 is a cloud server.

The server 30 is communicatively connected to the terminal device 40 via communication via a wire or wireless. In the example shown in FIG. 1, the server 30 is communicably connected to the terminal device 40 by wireless communication. The communication network connecting the server 30 and the terminal device 40 may be, for example, the LAN in the facility where the server 30 is installed, may be the Internet, may be the mobile communication network, or may be another communication network. Hereinafter, as an example, a case where the communication network connecting the server 30 and the terminal device 40 is the Internet will be described.

### Hardware Configuration of Server

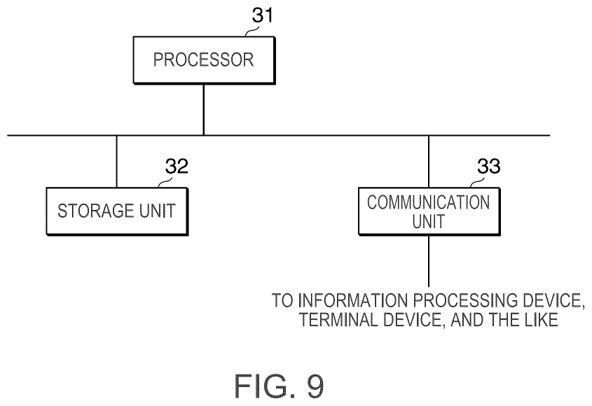

Hereinafter, the hardware configuration of the server 30 will be described with reference to FIG. 9. FIG. 9 is a diagram showing an example of a hardware configuration of the server 30.

The server 30 includes, for example, a processor 31, a storage section 32, and a communication section 33. These components are communicably connected to each other via a bus. The server 30 communicates with both each of the information process device 20 and the terminal device 40 via the communication section 33.

The processor 31 is, for example, a Central Processing Unit (CPU). Note that the processor 31 may be another processor such as a Field Programmable Gate Array (FPGA) instead of the CPU. The processor 31 executes various programs stored in the storage section 32.

The storage section 32 is a storage device including, for example, a Hard Disk Drive (HDD), a Solid State Drive (SSD), an Electrically Erasable Programmable Read Only Memory (EEPROM), a Read Only Memory (ROM), and a Random Access Memory (RAM). Note that the storage section 32 instead of being built into the server 30, may be an external storage device connected by a digital input-output port such as Universal Serial Bus (USB). The storage section 32 stores various information, various images, and various programs processed by the server 30. That is, various kinds of information stored in the server 30 are stored in storage section 32.

The communication section 33 is a communication device configured to include, for example, the digital input/output port such as the USB, an Ethernet (R) port, and an antenna for wireless communication.

### Functional Configuration of Server

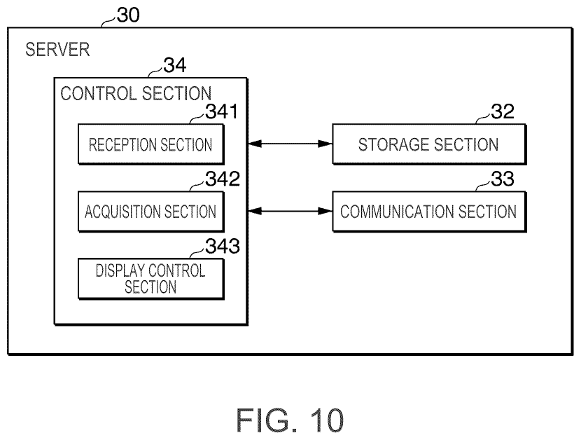

Hereinafter, the functional configuration of the server 30 will be described with reference to FIG. 10. FIG. 10 is a diagram showing an example of a functional configuration of the server 30.

The server 30 includes the storage section 32, the communication section 33, and a control section 34.

The control section 34 controls the entire server 30. The control section 34 includes a reception section 341, an acquisition section 342, and a display control section 343. These functional units included in the control section 34 are realized, for example, by the processor 31 executing various programs stored in the storage section 32. Some or all of the functional sections may be hardware functional sections such as a Large Scale Integration (LSI) and an Application Specific Integrated Circuit (ASIC).

The reception section 341 receives various kinds of information and various kinds of operations from a device communicably connected to the server 30.

The acquisition section 342 acquires, for each of the plurality of managed devices 10, the state information for the managed device 10 from the managed device 10 via the information process device 20. The acquisition section 342 may be configured to acquire the state information directly from the managed device 10 without using the information process device 20.

The display control section 343 generates various types of images according to operations received via the reception section 341. The display control section 343 transmits the generated image to the terminal device 40 and causes the terminal device 40 to display the image.

Process in which the Server Adds the Material Consumption Action Related Information to the Manufacturing Lot Information

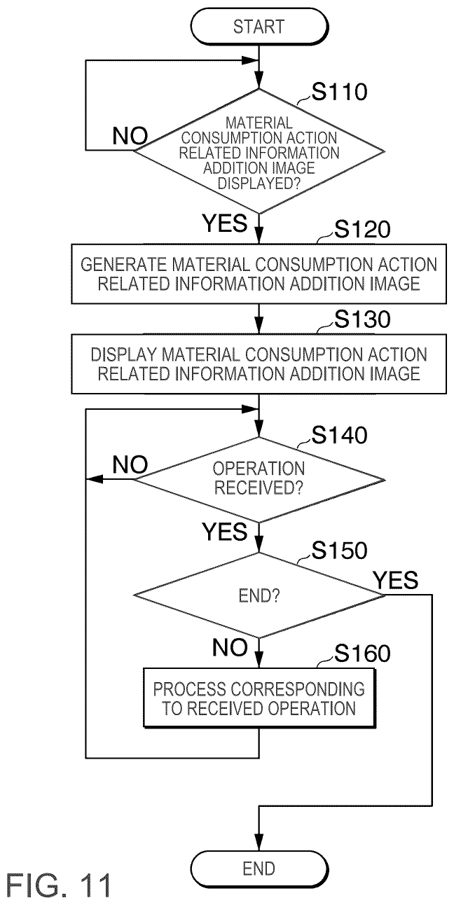

A process in which the server 30 adds the material consumption action related information to the manufacturing lot information will be described with reference to FIG. 11. FIG. 11 is a diagram showing an example of a flow of process in which the server 30 adds the material consumption action related information to the manufacturing lot information. Hereinafter, as an example, a case will be described in which the terminal image P2 is displayed on the terminal device 40 at a timing before the process of step S110 shown in FIG. 11 is performed. Hereinafter, as an example, a case will be described in which the master data and the product lot information are already stored in the server 30 at the timing.

The control section 34 waits until a selection operation at the button B21 is received, that is, an operation for displaying the material consumption action related information addition image P3 via the terminal device 40 (step S110). In FIG. 11, the process of step S110 is indicated by “MATERIAL CONSUMPTION ACTION RELATED INFORMATION ADDITION IMAGE DISPLAYED?”.

When the control section 34 determines that the operation for displaying the material consumption action related information addition image P3 was received via the terminal device 40 (YES in step S110), it generates the material consumption action related information addition image P3 (step S120). The method of generating the material consumption action related information addition image P3 in step S120 may be a known method or a method to be developed.

Next, the control section 34 transmits the material consumption action related information addition image P3 generated in step S120 to the terminal device 40 and causes the terminal device 40 to display the material consumption action related information addition image P3 (step S130).

Next, the control section 34 waits until an operation is received via the material consumption action related information addition image P3 displayed on the terminal device 40 (step S140). In FIG. 11, the process of step S140 is indicated by “OPERATION RECEIVED?”. When the control section 34 determines that the operation was received via the material consumption action related information addition image P3 displayed on the terminal device 40 (YES in step S140), it determines whether or not the received operation is an operation for ending the processing of the flowchart shown in FIG. 11 (step S150). The determination process of step S150 by the control section 34 may be performed by a known method or a method to be developed. In FIG. 11, the processing of step S150 is indicated by “END?”.

When the control section 34 determines that the operation received in step S140 is the operation for ending the process of the flowchart shown in FIG. 11 (YES in step S150), it deletes, for example, the display of the material consumption action related information addition image P3 from the terminal device 40, and ends the process of the flowchart shown in FIG. 11.

On the other hand, when the control section 34 determines that the operation received in step S140 is not the operation for ending the process of the flowchart shown in FIG. 11 (NO in step S150), it performs a process corresponding to the received operation (step S160). Here, since the process performed by the control section 34 in step S160 has already been described in the description of FIG. 4 to FIG. 8, a detailed description will be omitted.

After the process of step S160 is performed, the control section 34 proceeds to step S140 and waits again until an operation is received via the material consumption action related information addition image P3 displayed on the terminal device 40.

By processing as described above, the server 30 causes display of the material consumption action related information addition image P3 for receiving the material consumption action related information addition operation for adding the material consumption action related information related to the action of consuming the material used for molding the product to adjust the injection molding device to the manufacturing lot information indicating the target manufacturing lot selected from the manufacturing lots indicated by one or more sets of manufacturing lot information stored in storage section 32. By this, when an action that consumes the material used for molding the product for the adjustment of the injection molding device is performed, the server 30 can suppress the occurrence of a difference between the actual manufacturing lot and the manufacturing lot in the molding management system 1.

Note that the molding management system 1 described above may be configured to include the terminal device 40.

The above described search for the product lot may be performed using a time period in which the product lot was not operating normally as the search key. In this case, the product lot related information includes information indicating the time period.

The above described search for the product lot may be performed using one or more sets of information included in the injection molding device related information as the search key. In this case, the product lot related information includes the injection molding device related information. The injection molding device related information included in the product lot related information related to a certain product lot is information related to the injection molding device that molds the products of the product lot, and as described above, for example, is information including the operating state information indicating the operating state of the injection molding device, the detection information regarding the injection molding device, and the like. By this, the server 30 can more reliably improve the traceability of the product.

The above described search for the product lot may be performed using any arbitrary string as the search key. In this case, when the server 30 receives an arbitrary character string, it specifies information including the received character string from one or more sets of information included in the product lot related information and it causes display of a list of the product lot information indicating the product lot identified by each set of product lot identification information associated with the specified information. By this, the server 30 can make it easier for the user to search for the product lot.

The above described search for the manufacturing lot may be performed using any arbitrary string as the search key. In this case, when the server 30 receives an arbitrary character string, it specifies information including the received character string from one or more sets of information included in the manufacturing lot related information and it causes display of a list of manufacturing lot information indicating the manufacturing lot identified by each set of manufacturing lot identification information associated with the specified information. By this, the server 30 can make it easier for the user to search for the manufacturing lot. As a result, for example, the server 30 can allow the user to appropriately grasp the amount of the material put into the injection molding device, the amount of the material stored in the storage location, and the like. This is useful because it allows the user to accurately manage the timing and the amount of the material to be put into the injection molding device and allows the user to accurately manage the timing and the amount of the material to be carried into the storage place. The server 30 adds the purge related information and the trial shot related information to the manufacturing lot, the product lot, and the like, thereby making it possible to perform various analyses on the amount of the material used. For example, in the molding of a product of the injection molding device in a certain manufacturing lot, when the number of trial shots is large and the quality is not stable, there is a possibility that the metal mold attached to the injection molding device has reached the end of its life. In the molding of a product of the injection molding device in a certain manufacturing lot, when the purging is large and the replacement of the material put into the injection molding device is large, there is a possibility that the production schedule of the product of the product lot included in the manufacturing lot is not optimized. The server 30 can use the purge related information and the trial shot related information in order to analyze these possibilities.

The contents described above may be combined in any manner.

### Appendices

[1] A molding management system that manages production of a product in a production process including an injection molding process of the product by an injection molding device, the molding management system including a server communicably connected to a terminal device, wherein the server includes a storage section configured to store one or more sets of lot information in which lot identification information for identifying a lot and lot related information including one or more sets of information relating to the lot are associated with each other and a control section configured to cause the terminal device to display a material consumption action related information addition image for receiving a material consumption action related information addition operation for adding, to the lot information indicating a target lot selected from the lots indicated by one or more sets of the lot information stored in the storage section, material consumption action related information related to an action that consumes the material used for molding the product for adjustment of the injection molding device.
[2] The molding management system according to [1], wherein the action is a purging of the material.
[3] The molding management system according to [1], wherein the action is a trial shot by the injection molding device.
[4] The molding management system according to any one of [1] to [3], wherein the lot is a manufacturing lot.
[5] The molding management system, according to any one of [1] to [3], wherein the lot is a lot of the product.
[6] The molding management system, according to any one of [1] to [5], wherein the material consumption action related information addition image includes a material consumption information input image for receiving an operation of inputting information indicating amount of consumption of the material.
[7] The molding management system according to any one of [1] to [6], wherein the material consumption action related information addition image includes a material use action type selection image for receiving an operation of selecting the type of the action.
[8] The molding management system according to any one of [1] to [7], wherein the control section causes the terminal device to display a correspondence relationship reception image for associating, with the material consumption action related information, shot identification information for identifying a shot by which the product was molded.
[9] The molding management system according to any one of [1] to [8], wherein the lot related information includes, as one or more sets of information, injection molding device related information related to the injection molding device that molds the product of the lot identified by the lot identification information associated with the lot related information and the injection molding device related information includes at least one of operating state information indicating an operating state of the injection molding device or detection information detected by each of one or more of sensors attached to the injection molding device.

Note that the injection molding device described in [9] may be the same injection molding device as the one described in [1], or it may be a different injection molding device from the one described in [1]. Therefore, the article used for injection molding device in [9] is “a” and not “the”.

The molding management system according to any one of [1] to [9], wherein the lot related information includes quality information of the product of the lot identified by the lot identification information associated with the lot related information.

The molding management system according to any one of [1] to [10], wherein the lot related information includes process information indicating the work process currently performed on the product of the lot identified by the lot identification information associated with the lot related information.

The molding management system according to any one of [1] to [11], wherein the lot related information includes production plan information indicating a production plan for the product of the lot identified by the lot identification information associated with the lot related information.

The molding management system according to any one of [1] to [12], wherein the material consumption action related information includes information indicating an amount by which the material is consumed by the action.

The molding management system according to [1], wherein the material consumption action related information addition image includes history information indicating a history of the action performed in the past.

The molding management system according to any one of [1] to [13], further includes the terminal device.

The molding management system according to any one of [1] to [14], further includes the injection molding device.

Although the embodiments of the present disclosure have been described in detail with reference to the drawings, specific configurations are not limited to the embodiments, and changes, substitutions, deletions, and the like may be made without departing from the gist of the present disclosure.

A program for realizing a function of an arbitrary configuration section in the device described above may be recorded in a computer-readable recording medium, and the program may be read and executed by a computer system. Here, the device is, for example, the injection molding device 11, the information process device 20, the server 30, the terminal device 40, or the like. Note that the term “computer system” as used herein includes an Operating System (OS) and hardware such as peripheral devices. The “computer-readable recording medium” refers to a portable medium such as a flexible disk, a magneto-optical disk, a ROM, or a Compact Disk (CD)-ROM, or a storage device such as a hard disk built in the computer system. Further, “computer-readable recording medium” includes a medium that holds a program for a certain period of time, such as a volatile memory inside a computer system serving as a server or a client when the program is transmitted via a network such as the Internet or a communication line such as a telephone line.

The program may be transmitted from the computer system in which the program is stored in the storage device or the like to another computer system via a transmission medium or by a transmission wave in the transmission medium. Here, “transmission medium” for transmitting the program refers to a medium having a function of transmitting information such as a network such as the Internet or a communication line such as a telephone line.

The above described program may be a program for realizing a part of the above described functions. Further, the above described program may be a so-called difference file or difference program that can realize the above described functions in combination with a program already recorded in the computer system.

What is claimed is:

1. A molding management system that manages production of a product in a production process including an injection molding process of the product by an injection molding device, the molding management system comprising a server communicably connected to a terminal device, wherein the server includes
a storage section configured to store one or more sets of lot information in which lot identification information for identifying a lot and lot related information including one or more sets of information relating to the lot are associated with each other and
a control section configured to cause the terminal device to display a material consumption action related information addition image for receiving a material consumption action related information addition operation for adding, to the lot information indicating a target lot selected from the lots indicated by one or more sets of the lot information stored in the storage section, material consumption action related information related to an action that consumes the material used for molding the product for adjustment of the injection molding device.

2. The molding management system according to claim 1, wherein
the action is a purging of the material.

3. The molding management system according to claim 1, wherein
the action is a trial shot by the injection molding device.

4. The molding management system according to claim 1, wherein
the lot is a manufacturing lot.

5. The molding management system according to claim 1, wherein
the lot is a lot of the product.

6. The molding management system according to claim 1, wherein
the material consumption action related information addition image includes a material consumption information input image for receiving an operation of inputting information indicating amount of consumption of the material.

7. The molding management system according to claim 1, wherein
the material consumption action related information addition image includes a material use action type selection image for receiving an operation of selecting the type of the action.

8. The molding management system according to claim 1, wherein
the control section causes the terminal device to display a correspondence relationship reception image for associating, with the material consumption action related information, shot identification information for identifying a shot by which the product was molded.

9. The molding management system according to claim 1, wherein
the lot related information includes, as one or more sets of information, injection molding device related information related to the injection molding device that molds the product of the lot identified by the lot identification information associated with the lot related information and
the injection molding device related information includes at least one of operating state information indicating an operating state of the injection molding device or detection information detected by each of one or more of sensors attached to the injection molding device.

10. The molding management system according to claim 1, wherein
the lot related information includes quality information of the product of the lot identified by the lot identification information associated with the lot related information.

11. The molding management system according to claim 1, wherein
the lot related information includes process information indicating the work process currently performed on the product of the lot identified by the lot identification information associated with the lot related information.

12. The molding management system according to claim 1, wherein
the lot related information includes production plan information indicating a production plan for the product of the lot identified by the lot identification information associated with the lot related information.

13. The molding management system according to claim 1, wherein
the material consumption action related information includes information indicating an amount by which the material is consumed by the action.

14. The molding management system according to claim 1, wherein
the material consumption action related information addition image includes history information indicating a history of the action performed in the past.

15. The molding management system according to claim 1, further comprising:
the terminal device.

16. The molding management system according to claim 1, further comprising:
the injection molding device.
